(19) United States
(12) Patent Application Publication
(10) Pub. No.: US 2026/0280976 A1
(43) Pub. Date: Sep. 17, 2026

(54) Network power optimization

(71) Applicant: Mellanox Technologies, Ltd., Yokneam (IL)

(72) Inventors: Michael Weiner, Nes Ziona (IL); Elazar Cohen, Haifa (IL); Amit Kazimirsky, Givat Shmuel (IL); Alexander Agronin, Yokneam Ilit (IL); Idan Borshteen, Carmiel (IL)

(21) Appl. No.: 19/350,016

(22) Filed: Oct. 5, 2025

Related U.S. Application Data
(63) Continuation-in-part of application No. 19/081,023, filed on Mar. 17, 2025.

(51) Int. Cl. H04L 41/0803

(52) U.S. Cl. CPC H04L 41/0803

(57) ABSTRACT

In one embodiment, a system for network power optimization includes a plurality of network planes, a plurality of network-enabled devices, each of the network-enabled devices being connected to each of the network planes, and a controller to select a subset of the plurality of network planes for at least one network-enabled device of the plurality of network-enabled devices to send traffic over, allowing at least one unused network plane to enter a lower power mode.

### RELATED APPLICATION INFORMATION

The present application is a Continuation-in-Part of S/N 19/081,023 of Sucher, et al., filed Mar. 17, 2025, the disclosure of which is hereby incorporated herein by reference.

### FIELD OF THE DISCLOSURE

The present disclosure relates to computer systems, and more particularly but not exclusively to, power management.

### BACKGROUND

Modern data centers and high-performance computing environments have evolved to support increasingly demanding computational workloads, including artificial intelligence, machine learning, and large-scale data processing applications. These environments typically comprise numerous interconnected computing nodes, each equipped with processing units such as CPUs and GPUs, along with network interface cards that enable communication across the system.

Network architectures in these environments have grown in complexity to accommodate the substantial bandwidth and low-latency requirements of contemporary applications. Multi-plane network topologies have emerged as one approach to address scalability and performance demands. In such architectures, the network infrastructure is divided into multiple parallel planes, each providing independent paths for data transmission between network endpoints.

Each network plane in a multi-plane architecture typically comprises its own dedicated set of network components, including switches, routers, links, and associated hardware that operate independently from other network planes. This separation allows for parallel communication paths, load distribution capabilities, and enhanced fault tolerance. Network-enabled devices, such as network interface controllers (NICs), in these systems are commonly connected to multiple planes simultaneously, enabling traffic to be distributed across different paths based on various factors such as load balancing algorithms and routing policies.

Power consumption has become an increasingly prominent consideration in the design and operation of large-scale computing systems. Data centers consume substantial amounts of electrical energy, with network infrastructure representing a notable portion of overall power usage. Network devices, including switches, routers, and network interface cards, typically support various power states that allow for dynamic adjustment of power consumption based on operational requirements.

These power states, which may range from fully operational modes to various levels of reduced power consumption, enable network components to conserve energy during periods of lower activity. However, managing power states across complex multi-plane network architectures presents various challenges related to coordination, performance maintenance, and system-wide optimization.

The scale and complexity of modern data center networks, combined with the dynamic nature of computational workloads, create opportunities for more sophisticated approaches to network resource management and power optimization. As these systems continue to grow in size and complexity, there is ongoing interest in developing methods that can balance performance requirements with energy efficiency considerations.

### OVERVIEW

There is provided in accordance with an embodiment of the present disclosure, a system for network power optimization, comprising a plurality of network planes, a plurality of network-enabled devices, each of the network-enabled devices being connected to each of the network planes, and a controller to select a subset of the plurality of network planes for at least one network-enabled device of the plurality of network-enabled devices to send traffic over, allowing at least one unused network plane to enter a lower power mode.

Further in accordance with an embodiment of the present disclosure, the system further comprises a power management subsystem to control power modes of the plurality of network planes and transition the at least one unused network plane to the lower power mode.

Still further in accordance with an embodiment of the present disclosure, the controller comprises distributed control logic integrated within each of the plurality of network-enabled devices, wherein the distributed control logic in each network-enabled device is to select a respective subset of the plurality of network planes over which to send traffic.

Additionally, in accordance with an embodiment of the present disclosure, the controller is a centralized orchestrator to select the subset of the plurality of network planes over which to send traffic for multiple network-enabled devices of the plurality of network-enabled devices to coordinate power states across the plurality of network planes to synchronize transitions between power modes for network-wide energy optimization.

Moreover, in accordance with an embodiment of the present disclosure, the controller is to select the subset of the plurality of network planes based on any one or more of the following current traffic volume, a time of day, energy consumption data, quality-of-service requirements, or schedule sensitivity.

Further in accordance with an embodiment of the present disclosure, each network plane of the plurality of network planes comprises spine switches and leaf switches arranged in a hierarchical topology.

Still further in accordance with an embodiment of the present disclosure, the plurality of network-enabled devices are connected to leaf switches across multiple network planes of the plurality of network planes.

Additionally, in accordance with an embodiment of the present disclosure, the controller instructs the at least one network-enabled device to route traffic through the selected subset of the plurality of network planes while bypassing the at least one unused network plane.

Moreover, in accordance with an embodiment of the present disclosure, the controller is to predictively activate the at least one unused network plane prior to anticipated traffic demand based on any one or more of the following historical traffic patterns, machine learning algorithms, or scheduled workload information.

Further in accordance with an embodiment of the present disclosure, the controller is to predictively power up switches and links in the at least one unused network plane prior to the anticipated traffic demand.

Still further in accordance with an embodiment of the present disclosure, the controller is to maintain a minimum number of active network planes from the plurality of network planes to provide network redundancy.

Additionally, in accordance with an embodiment of the present disclosure, the controller is to select the subset of the plurality network planes based on quality-of-service requirements associated with different types of network traffic.

Moreover, in accordance with an embodiment of the present disclosure, the controller is to monitor network utilization across the plurality of network planes and adjust the selected subset based on detected traffic patterns.

Further in accordance with an embodiment of the present disclosure, the at least one network-enabled device is to load balance traffic across the selected subset of the plurality of network planes to optimize performance and power consumption.

There is provided in accordance with another embodiment of the present disclosure, a controller for network power optimization, comprising processing circuitry to select a subset of a plurality of network planes for at least one network-enabled device to send traffic over allowing at least one unused network plane to enter a lower power mode, and instruct the at least one network-enabled device to route traffic through the selected subset of the plurality of network planes while bypassing the at least one unused network plane, and memory to store data used by the processing circuitry.

Still further in accordance with an embodiment of the present disclosure, the processing circuitry is to coordinate power states across the plurality of network planes to synchronize transitions between power modes for network-wide energy optimization.

Additionally, in accordance with an embodiment of the present disclosure, the processing circuitry is to select the subset of network planes based on any one or more of the following current traffic volume, a time of day, energy consumption data, quality-of-service requirements, or schedule sensitivity.

Moreover, in accordance with an embodiment of the present disclosure, the processing circuitry is to predictively activate the at least one unused network plane prior to anticipated traffic demand based on any one or more of the following historical traffic patterns, machine learning algorithms, or scheduled workload information.

Further in accordance with an embodiment of the present disclosure, the processing circuitry is to predictively power up switches and links in the at least one unused network plane prior to the anticipated traffic demand.

Still further in accordance with an embodiment of the present disclosure, the processing circuitry is to maintain a minimum number of active network planes from the plurality of network planes to provide network redundancy.

Additionally, in accordance with an embodiment of the present disclosure, the processing circuitry is to select the subset of network planes based on quality-of-service requirements associated with different types of network traffic.

Moreover, in accordance with an embodiment of the present disclosure, the processing circuitry is to monitor network utilization across the plurality of network planes and adjust the selected subset based on detected traffic patterns.

There is also provided in accordance with still another embodiment of the present disclosure, a method for network power optimization, comprising selecting a subset of a plurality of network planes for at least one network-enabled device to send traffic over allowing at least one unused network plane to enter a lower power mode, and instructing the at least one network-enabled device to route traffic through the selected subset of the plurality of network planes while bypassing the at least one unused network plane.

### BRIEF DESCRIPTION OF THE DRAWINGS

The present disclosure will be understood from the following detailed description, taken in conjunction with the drawings in which:

FIG. 1 is a simplified pictorial illustration of a computer system constructed and operative in accordance with an embodiment of the present disclosure;

FIG. 2 is a more detailed view of a network orchestrator in the system of FIG. 1;

FIG. 3 is a flowchart including steps in a method of operation of the network orchestrator of FIG. 2;

FIG. 4 is a more detailed view of a processing node in the system of FIG. 1;

FIG. 5 is a flowchart including steps in a method of operation of the processing node of FIG. 4;

FIG. 6 is a port power graph illustrating a configuration where all ports are active;

FIG. 7 is a port power graph illustrating a configuration where a subset of ports are active;

FIG. 8 is a partly pictorial, partly block diagram view of a network system for managing power consumption across multiple network planes, constructed and operative in accordance with an embodiment of the present disclosure;

FIG. 9 is a more detailed view of a controller in the system of FIG. 8;

FIG. 10 is a flowchart including steps in a method for network power optimization of the network system of FIG. 8;

FIG. 11 is a more detailed view of a network-enabled device in the system of FIG. 8;

FIG. 12 is a flowchart including steps in a routing method of operation of the network-enabled device of FIG. 11; and

FIG. 13 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW OF EXAMPLE EMBODIMENTS

In modern data centers and high-performance computing environments, network power management presents significant challenges that limit energy efficiency and system optimization. Current decentralized approaches to power state management operate at the individual link level, where each network link makes autonomous decisions to enter low-power states during idle periods. This decentralized methodology creates several critical problems: suboptimal power-latency trade-offs that prioritize local power savings over global performance, leading to frequent and unnecessary state transitions that are particularly detrimental for bursty workloads common in data centers; lack of cross-link coordination that results in cascading wake-up delays in multi-tiered topologies and inefficient resource allocation; inconsistent policy enforcement across heterogeneous environments with components from multiple vendors, leading to unpredictable behavior; missed cross-layer optimization opportunities due to isolation from higher-layer protocols and applications; and scalability challenges in large-scale deployments where uncoordinated power state transitions across thousands of devices can create localized thermal hotspots and increase cooling costs.

The need for a more sophisticated approach to network power management has become increasingly urgent as data centers continue to grow in size and complexity. Multi-plane network architectures, which divide network infrastructure into multiple parallel planes to enhance scalability and performance, present both opportunities and challenges for power optimization. Without proper coordination, these architectures can result in significant energy waste during periods of low network utilization, where traffic is distributed across all available planes even when fewer planes could handle the workload efficiently. The importance of addressing these issues extends beyond simple energy savings to encompass overall system performance, operational costs, and environmental sustainability in large-scale computing environments.

Existing solutions have attempted to address power management through various approaches, but these suffer from notable limitations. Traditional link-level power management operates in isolation without awareness of broader network context, leading to suboptimal decisions. Some centralized approaches have been proposed but typically focus on individual switches or limited network segments rather than providing comprehensive, network-wide coordination. These solutions also fail to leverage the unique characteristics of multi-plane architectures where entire planes can be selectively activated or deactivated based on traffic demands.

Embodiments of the present disclosure address at least some of the above drawbacks by providing a system for network power optimization that includes a plurality of network planes, a plurality of network-enabled devices connected to each of the network planes, and a controller that selects a subset of the plurality of network planes for network-enabled devices to send traffic over, allowing unused network planes to automatically enter a lower power mode.

In some embodiments, the system employs a centralized orchestrator that coordinates power states across all network planes to eliminate the inefficiencies of per-link decisions. The orchestrator can batch idle periods across multiple links and planes, allowing entire switches or planes to enter low-power states during coordinated idle windows. In some cases, the system consolidates data flows onto fewer planes and physical links, enabling unused switches to enter low-power states or shut down entirely, achieving significantly greater power savings than isolated link-level transitions. Alternatively, the system may implement a distributed solution where individual network-enabled devices include a controller to decide the selection of network planes, allowing each device to independently determine which subset of available planes to utilize based on local traffic patterns and power optimization goals.

In some embodiments, the controller implements predictive wake-up mechanisms using workload telemetry and application-level hints to anticipate traffic bursts and preemptively transition links or planes to active states. This predictive approach addresses the wake-up latency challenges inherent in power state transitions by ensuring that network resources are available when needed. In some cases, the system can synchronize state exits across dependent links in a data path to prevent cumulative latency penalties that arise from staggered, autonomous transitions.

In some embodiments, the system dynamically adjusts the number of active network planes based on real-time bandwidth demand, scaling network resources up or down as needed to balance performance and power consumption. The controller can prioritize critical links to remain in lower-latency power states while allowing non-critical links to enter deeper power-saving states. In some cases, the system enforces uniform power management policies across devices and vendors, leveraging system-wide telemetry and orchestration integration to ensure consistent behavior.

In some embodiments, the system maintains network redundancy by ensuring a minimum number of active network planes remain operational at all times. The controller can select network planes based on quality-of-service requirements associated with different types of network traffic, ensuring that performance-critical applications receive appropriate network resources. In some cases, the system continuously monitors network utilization patterns and adjusts the selected subset of active planes based on detected traffic changes, providing adaptive power management that responds to evolving network demands.

### DEFINITIONS

As used herein, the term "processing node" may refer to a computational unit capable of executing instructions and processing data. In some cases, a processing node may be a graphics processing unit (GPU) or a central processing unit (CPU). A processing node may be interconnected with other processing nodes through a network architecture.

As used herein, the term "link" or "network link" may refer to a physical or logical connection that enables data transmission between two network nodes, such as devices, switches, or other network components. A link may include the physical medium, signaling protocols, and associated hardware required for communication. For example, an Ethernet cable and associated transceivers connecting a server to a network switch, or a high-speed interconnect link between processing nodes in a computing cluster.

As used herein, the term "routing profile" may refer to a set of instructions or parameters that define how network traffic should be directed through available communication ports of a processing node. In some cases, a routing profile may specify which subset of available ports should be used for routing traffic, and for which class of traffic (e.g., non-essential or essential).

As used herein, the term "low-power state" or "low power mode" may refer to an operational state of a device or component where power consumption is reduced compared to normal active operation. Low power modes may include various levels of power reduction, from slight decreases in power consumption to near-complete shutdown of non-essential functions. For example, an L1 power state where network links reduce power consumption while maintaining the ability to quickly return to full operation, or a deep sleep mode where entire network switches power down most circuitry while retaining basic monitoring capabilities.

As used herein, the term "routing device" may refer to a component within a processing node that manages the routing of network traffic through the node's communication ports. In some cases, the routing device may be referred to as an HSHUB (High-Speed Hub). The routing device may implement routing profiles to control traffic flow through the processing node.

As used herein, the term "node interconnect network" may refer to a communication infrastructure that facilitates data exchange between multiple processing nodes in a computing system. This network may comprise various components such as network links, switches, and communication ports, which collectively enable data transfer between nodes (e.g., high-speed, low-latency data transfer between nodes). In some cases, a node interconnect network may support different topologies and protocols to optimize performance for specific computational tasks or system architectures.

As used herein, the term "network plane" may refer to an independent network infrastructure that provides a separate path for data transmission between network endpoints. A network plane may be implemented in one of three ways: (1) as a physically separate network infrastructure with its own dedicated set of network components including switches, routers, links, and associated hardware that operate independently from other network planes; (2) as a logically separated network where multiple network planes share physical infrastructure but maintain independent data paths through logical partitioning, virtual networking, or software-defined networking techniques; or (3) as a combination of physical and logical separation. In a common implementation, multiple ports on a network interface card (NIC) may be connected to the same network plane (e.g., in an 8-port NIC connected to 4 planes, each pair of ports may connect to a different plane).

A network plane differs from a control plane and a data plane, which represent functional layers within network architecture rather than physical network infrastructures. The control plane may refer to the portion of a network that carries signaling traffic and is responsible for routing decisions, network topology discovery, and the exchange of routing information between network devices. The control plane may include protocols and processes that determine how data should be forwarded through the network.

The data plane, also referred to as the forwarding plane, may refer to the portion of a network that carries user traffic and is responsible for the actual forwarding of data packets based on decisions made by the control plane. The data plane may include the hardware and software components that perform packet forwarding, filtering, and other data processing functions.

In contrast to these functional planes, a network plane as used herein represents a complete, independent network infrastructure that may have its own control plane and data plane components. Multiple network planes may operate in parallel within a multi-plane network architecture, where each plane provides a separate physical or logical path for network communication. In some cases, network planes may be selectively activated or deactivated to optimize power consumption while maintaining network connectivity and performance requirements.

As used herein, the term "subset of network planes" may refer to a selected group of one or more network planes from a larger set of available network planes in a multi-plane network architecture. The subset may include any number of network planes less than or equal to the total number of available planes. In some aspects, the subset of network planes may be dynamically determined based on various factors such as current network traffic, power consumption requirements, quality of service needs, or redundancy considerations. The subset of network planes may represent the active planes over which network traffic is routed at a given time, while other planes not included in the subset may be placed in a lower power state or deactivated, for example, automatically transitioning to a lower power state via disuse. In some cases, the composition of the subset may change over time as network conditions and requirements evolve.

As used herein, the term "at least one unused network plane" may refer to one or more network planes within a multi-plane network architecture that are not currently being utilized for active data transmission. In some aspects, an unused network plane may be a network plane that is not part of the selected subset of active network planes over which traffic is being routed at a given time. Unused network planes may be candidates for entering a lower power mode to conserve energy. In some cases, an unused network plane may be in a standby state, ready to be activated quickly if network conditions change. The status of a network plane as "unused" may be temporary and subject to change based on factors such as traffic demands, power optimization strategies, or system policies.

As used herein, the term "schedule sensitivity" may refer to the degree to which network traffic patterns or workload demands are influenced by predetermined or anticipated time-based events or schedules, as well as the flexibility in transmission timing and bandwidth requirements. In some aspects, schedule sensitivity may encompass the predictability of network usage based on factors such as regular business hours, planned maintenance windows, scheduled batch processes, or recurring data transfers. Traffic with low schedule sensitivity can be transmitted at a lower rate over a longer period of time, requiring fewer network planes, while time-critical traffic with high schedule sensitivity requires more immediate transmission and potentially more network planes. Schedule sensitivity may be used to inform network resource allocation and power management decisions, allowing the system to proactively adjust network plane utilization in anticipation of known or expected changes in traffic volume or patterns, and to appropriately allocate network resources based on the urgency and bandwidth requirements of different traffic types.

As used herein, the term "network-enabled devices" may refer to computing or networking components that have the capability to connect to and communicate over one or more network infrastructures. Network-enabled devices may include servers, graphics processing units (GPUs), central processing units (CPUs), network interface cards (NICs), data processing units (DPUs), switches, routers, or any other devices capable of sending and receiving network traffic. For example, a GPU cluster in a data center where each GPU has multiple network connections, or a server with multiple network interface cards connected to different network planes.

As used herein, the term "server" may refer to a computing device or system that provides services, resources, or data to other devices or clients over a network. A server may include one or more processors, memory, storage, and network interfaces to handle requests and deliver responses. For example, a web server that hosts websites and responds to HTTP requests, or a database server that stores and manages data for multiple client applications.

As used herein, the term "storage device" may refer to a hardware component or system designed to store and retrieve digital data persistently. Storage devices may include hard disk drives, solid-state drives, network-attached storage systems, or storage area networks. For example, an NVMe solid-state drive that stores application data, or a distributed storage system that provides data redundancy across multiple physical drives.

As used herein, the term "controller" may refer to a hardware or software component that manages, coordinates, or directs the operation of other system components. In the context of network power optimization, a controller may make decisions about resource allocation, power states, and traffic routing. For example, a centralized controller that coordinates power management across multiple network planes, or a distributed controller embedded within individual network devices.

As used herein, the term "centralized orchestrator" may refer to a single, centralized system or component that coordinates and manages operations across multiple distributed elements in a network or computing environment. A centralized orchestrator may have a global view of system state and can make coordinated decisions for optimal performance. For example, a data center orchestrator that manages workload placement across multiple servers, or a network orchestrator that coordinates traffic routing and power management across all network planes.

As used herein, the term "processing circuitry" may refer to electronic components or circuits designed to execute instructions, perform computations, or process data. Processing circuitry may include processors, microcontrollers, application-specific integrated circuits (ASICs), field-programmable gate arrays (FPGAs), or other computational hardware. For example, a CPU that executes network management software, or dedicated packet processing circuitry within a network interface card.

As used herein, the term "memory" may refer to electronic storage components that hold data and instructions for use by processing circuitry. Memory may include volatile storage such as RAM or non-volatile storage such as flash memory, and can be used for temporary data storage or persistent information retention. For example, system RAM that stores running programs and data, or firmware memory that contains device configuration and control software.

As used herein, the term "network interface" may refer to a hardware or software component that enables a device to connect to and communicate over a network. A network interface may handle the physical and logical aspects of network communication, including data transmission, reception, and protocol processing. For example, an Ethernet network interface card that connects a server to a local area network, or a wireless network interface that enables mobile device connectivity.

As used herein, the term "switch" or "network switch" may refer to a networking device that connects multiple devices within a network and forwards data between them. A switch may learn device locations, maintain forwarding tables, and provide dedicated bandwidth to each connected device. For example, a leaf switch that connects servers to the network infrastructure, or a spine switch that provides connectivity between different network segments.

As used herein, the term "spine switch" may refer to a network switch that forms the backbone of a hierarchical network topology, typically connecting to multiple leaf switches to provide inter-rack or inter-segment connectivity. Spine switches may handle large volumes of traffic and provide high-bandwidth paths between different parts of the network. For example, a spine switch in a data center that connects multiple leaf switches to enable communication between different server racks, or a core spine switch that provides connectivity between different data center pods.

As used herein, the term "leaf switch" may refer to a network switch that connects directly to end devices such as servers, storage systems, or other network endpoints in a hierarchical network topology. Leaf switches may provide the first level of network connectivity for devices and typically connect upward to spine switches. For example, a top-of-rack leaf switch that connects servers within a single rack to the broader network infrastructure, or an access leaf switch that provides connectivity for end-user devices.

As used herein, the term "distributed control logic" may refer to control algorithms, decision-making processes, or management functions that are distributed across multiple components or devices rather than centralized in a single location. Distributed control logic may enable autonomous operation and local decision-making while maintaining coordination with other system elements. For example, load balancing logic distributed across multiple network interface cards that independently select which network planes to use, or power management logic embedded in individual switches that can make local power state decisions.

As used herein, the term "power management subsystem" may refer to a collection of hardware and software components responsible for monitoring, controlling, and optimizing power consumption within a system or device. A power management subsystem may include power monitoring circuits, control logic, and interfaces for managing different power states. For example, a subsystem within a network switch that monitors port utilization and transitions unused ports to low-power states, or a system-wide power management subsystem that coordinates power optimization across multiple network planes.

As used herein, the term "network power optimization" may refer to techniques, methods, or systems designed to reduce energy consumption in network infrastructure while maintaining required performance levels. Network power optimization may involve dynamic adjustment of power states, selective activation of network resources, and coordination of power management across multiple devices. For example, consolidating network traffic onto fewer active planes to allow unused planes to enter low-power states, or predictively powering up network resources based on anticipated traffic demands.

As used herein, the term "energy consumption data" may refer to information about the amount of electrical power being used by devices, components, or systems over time. Energy consumption data may include real-time power measurements, historical usage patterns, and efficiency metrics used for optimization decisions. For example, power consumption measurements from individual network ports used to determine which ports can be safely transitioned to low-power states, or aggregate energy usage data from network planes used to optimize overall system efficiency.

As used herein, the term "current traffic volume" may refer to the amount of network data being transmitted or processed at a given time, typically measured in units such as bits per second, packets per second, or bandwidth utilization percentage. Current traffic volume may be used to make decisions about resource allocation and power management. For example, measuring the data rate on network links to determine if traffic can be consolidated onto fewer active links, or monitoring packet rates to predict when additional network capacity may be needed.

As used herein, the term "quality of service requirements" may refer to specifications or criteria that define the performance characteristics needed for different types of network traffic or applications. Quality of service requirements may include parameters such as bandwidth, latency, packet loss tolerance, and priority levels. For example, low-latency requirements for real-time applications that may necessitate keeping certain network planes active, or high-bandwidth requirements for data transfers that may require activating additional network resources.

As used herein, the term "traffic" or "network traffic" may refer to data that is transmitted over a network infrastructure, including packets, frames, or other units of information being sent between network endpoints. Network traffic may vary in volume, type, priority, and destination, and can be analyzed for optimization purposes. For example, application data being transmitted between servers in a data center, or control messages being exchanged between network management systems.

As used herein, the term "power states" may refer to different operational modes that devices or components can enter to manage power consumption, ranging from fully active states to various levels of reduced power operation. Power states may be defined by industry standards or device-specific implementations and can affect both power consumption and performance characteristics. For example, L0 state representing full active operation and L1 state representing a low-power standby mode with reduced functionality, or device-specific power states that allow for fine-grained control over power consumption.

As used herein, the term "synchronize transitions" may refer to the coordination of power state changes or operational mode changes across multiple devices or components to occur at the same time or in a coordinated sequence. Synchronized transitions may prevent performance degradation and ensure system stability during power management operations. For example, coordinating the power-up sequence of multiple network switches to avoid cascading delays.

As used herein, the term "network conditions" may refer to the current state and characteristics of network infrastructure, including factors such as traffic load, device availability, link status, and performance metrics. Network conditions may change over time and can influence decisions about resource allocation and power management. For example, high network utilization that may require activating additional network planes, or low traffic periods that may allow for power optimization through resource consolidation.

As used herein, the term "dynamically adjust" may refer to the ability to modify system behavior, configuration, or resource allocation in real-time or near real-time based on changing conditions or requirements. Dynamic adjustment may involve automated decision-making processes that respond to monitored parameters or external inputs. For example, automatically increasing the number of active network planes when traffic volume exceeds a threshold, or dynamically redistributing traffic across available network resources based on current utilization patterns.

As used herein, the term "network wide energy optimization" may refer to power management strategies and techniques that consider the entire network infrastructure as a coordinated system to achieve maximum energy efficiency. Network-wide energy optimization may involve global decision-making that balances power consumption across multiple devices and components. For example, coordinating power states across all network planes in a data center to minimize total energy consumption while maintaining required performance levels, or optimizing power distribution between network infrastructure and compute resources based on current workload demands.

As used herein, the term "predictively activate" may refer to the process of transitioning devices, components, or resources from a low-power or inactive state to an active state in anticipation of future demand or requirements. Predictive activation may be based on historical patterns, scheduled events, or algorithmic predictions. For example, powering up network planes before anticipated traffic increases based on machine learning analysis of historical usage patterns, or activating additional network resources in advance of scheduled batch processing jobs.

As used herein, the term "predictively power up" may refer to the specific action of increasing power consumption or transitioning to higher power states in anticipation of future operational requirements. Predictive power-up may involve energizing circuits, initializing components, or preparing systems for increased activity levels. For example, bringing network switches out of low-power states before expected traffic bursts to avoid wake-up latency, or pre-activating network links based on predicted communication patterns between processing nodes.

As used herein, the term "anticipated traffic demand" may refer to expected or predicted future network usage based on analysis of patterns, schedules, or other indicators. Anticipated traffic demand may be used to make proactive decisions about resource allocation and power management. For example, predicting increased network activity during business hours based on historical usage patterns, or anticipating traffic spikes based on scheduled data processing jobs or application workloads.

As used herein, the term "network redundancy" may refer to the provision of backup or alternative network paths, devices, or resources that can maintain network connectivity and functionality in the event of failures or maintenance activities. Network redundancy may involve duplicate components, multiple paths, or failover mechanisms. For example, maintaining multiple active network planes to ensure continued connectivity if one plane fails, or keeping backup network switches ready to take over if primary switches become unavailable.

As used herein, the term "network utilization" may refer to the degree to which network resources such as bandwidth, ports, or processing capacity are being used at a given time, typically expressed as a percentage of total available capacity. Network utilization may be monitored and analyzed to make decisions about resource allocation and optimization. For example, measuring the percentage of available bandwidth being used on network links to determine if traffic can be consolidated, or monitoring switch port utilization to identify opportunities for power savings.

As used herein, the term "detected traffic patterns" may refer to identified characteristics, trends, or behaviors in network traffic that have been observed through monitoring and analysis. Detected traffic patterns may include periodic variations, usage trends, or communication relationships between network endpoints. For example, identifying daily patterns of increased network activity during business hours, or detecting communication patterns between specific servers that indicate application dependencies.

As used herein, the term "load balance" may refer to the distribution of network traffic, processing tasks, or resource utilization across multiple available paths, devices, or components to optimize performance and prevent overloading of individual elements. Load balancing may involve algorithms that dynamically distribute work based on current conditions. For example, distributing network traffic across multiple active network planes to maximize throughput and prevent congestion, or balancing processing tasks across multiple servers to optimize resource utilization.

As used herein, the term "optimize performance and power consumption" may refer to the process of achieving the best possible balance between system performance characteristics and energy efficiency through careful management of resources and operational parameters. This optimization may involve trade-offs between competing objectives and dynamic adjustment based on current requirements. For example, selecting the minimum number of active network planes needed to meet performance requirements while maximizing power savings, or adjusting network resource allocation to maintain quality of service while reducing overall energy consumption.

### SYSTEM DESCRIPTION

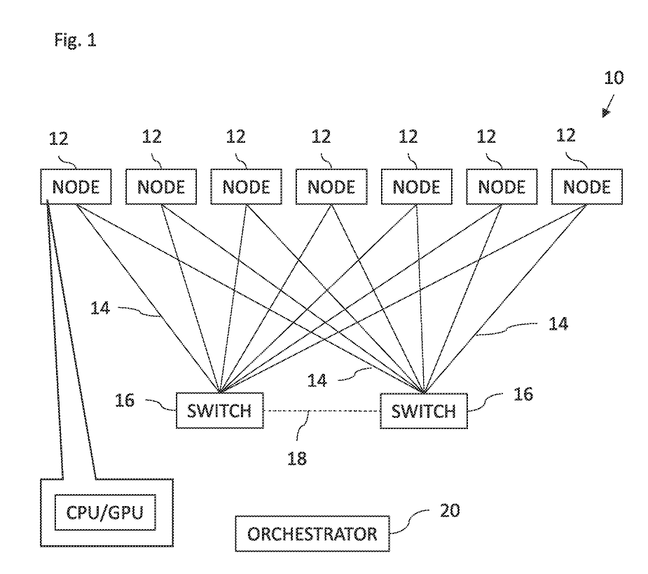

Reference is now made to FIG. 1, which is a simplified pictorial illustration of a computer system 10. The computer system 10 may include a plurality of processing nodes 12 interconnected via a network. The network may comprise network links 14, network switches 16, and switch interconnects 18.

In some cases, the processing nodes 12 may be connected to the network switches 16 through the network links 14. The network switches 16 may be connected to each other via the switch interconnects 18. This configuration may allow the processing nodes 12 to communicate with each other through multiple paths in the network.

The computer system 10 may also include a network orchestrator 20. The network orchestrator 20 may manage network operations and power consumption within the computer system 10.

In some cases, the network orchestrator 20 may determine link requirements based on factors such as network traffic, power consumption, and performance requirements like latency. The network orchestrator 20 may use these link requirements to configure routing profiles for the processing nodes 12.

The network switches 16 may play a role in power saving within the computer system 10. When certain network links 14 are not used due to the routing profiles implemented by the processing nodes 12, the corresponding ports on the network switches 16 may enter a low-power state. This may result in power savings not only on the processing nodes 12 but also on the network switches 16.

In some cases, when all ports on a network switch 16 are unused due to the routing profiles implemented by the processing nodes 12, the entire network switch 16 may enter a power-saving mode. This may occur when traffic patterns allow for consolidation of active connections onto fewer switches, enabling some switches to become completely idle. The power-saving mode for an entire switch may involve powering down non-essential components, reducing clock speeds, or utilizing other power management techniques. This approach may lead to even greater energy savings across the computer system 10, as entire switching units may operate at significantly reduced power levels during periods of low network utilization.

In some cases, the processing nodes 12 may include graphics processing units (GPUs) and/or central processing units (CPUs). The network orchestrator 20 may manage the routing of data traffic between these processing nodes 12 to optimize performance and power consumption across the computer system 10.

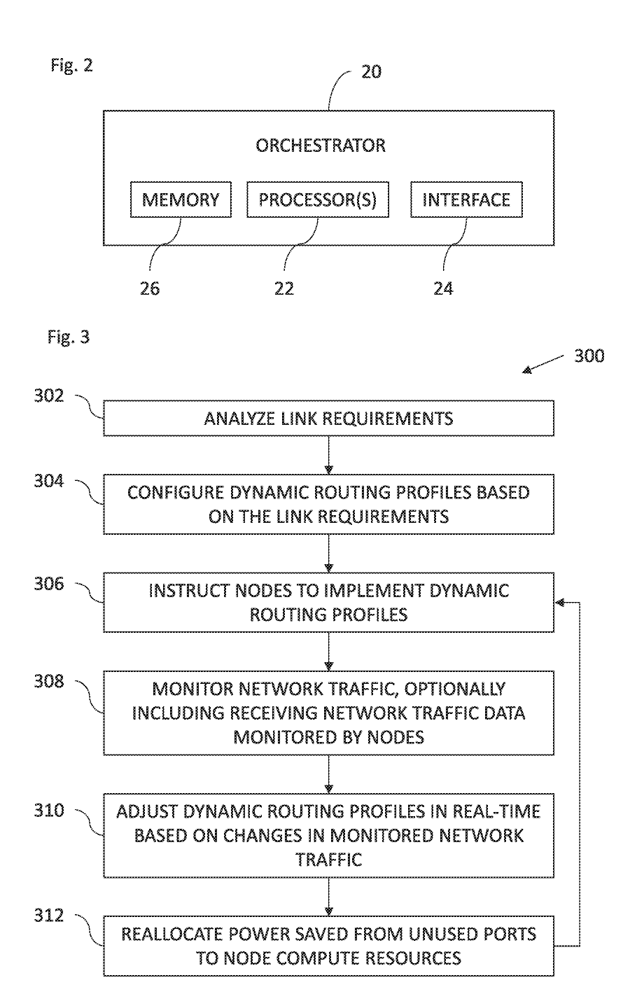

Reference is now made to FIGS. 2 and 3, which are a block diagram view of network orchestrator 20 and a flowchart including steps in a method 300, respectively.

Network orchestrator 20 may comprise processor(s) 22, an interface 24, and memory 26. The processor(s) 22 may be configured to analyze link requirements in a network interconnecting a plurality of nodes. Based on the analyzed link requirements, the processor(s) 22 may configure dynamic routing profiles for the plurality of nodes. The interface 24 may be used to share data with the nodes, including instructions to implement the dynamic routing profiles.

In some cases, the network orchestrator may determine link requirements through a multi-faceted analysis of network conditions and performance metrics. For example, the orchestrator may monitor real-time network traffic patterns, analyzing factors such as data transfer rates, packet sizes, and communication frequencies between specific node pairs. The orchestrator may also consider historical usage data to identify recurring patterns or trends in network utilization.

Additionally, the orchestrator may take into account power consumption data from individual ports and links, as well as overall system power usage. This information may be combined with performance requirements, such as maximum allowable latency for certain types of traffic or minimum bandwidth guarantees for critical applications.

Based on this comprehensive analysis, the orchestrator may identify opportunities for power optimization without compromising essential network performance. For instance, if the analysis reveals that certain node pairs consistently exchange large volumes of data while others communicate infrequently, this information may be used to shape the dynamic routing profiles.

Translating these link requirements into dynamic routing profiles may involve several steps. The orchestrator may first categorize traffic types based on their priority and performance needs. It may then determine the minimum number of active ports required to handle the current and anticipated network load while meeting performance targets.

For example, if the link requirement analysis indicates that a processing node typically utilizes only 60% of its available bandwidth, the orchestrator may generate a dynamic routing profile that activates only three out of four available ports. This profile may instruct the node's routing device to direct all traffic through ports 1, 2, and 3, while allowing port 4 to enter a low-power state.

The dynamic routing profile may also include rules for traffic prioritization. For instance, it may specify that high-priority, latency-sensitive traffic should be distributed across all active ports to minimize congestion, while lower-priority bulk data transfers may be confined to a subset of the active ports.

In some implementations, the orchestrator may create multiple routing profiles for each node, each optimized for different network conditions or time periods. The node may then switch between these profiles based on real-time instructions from the orchestrator or predefined triggers, allowing for adaptive power management that responds to changing network demands.

In some cases, the processor(s) 22 may monitor network traffic and adjust the dynamic routing profiles in real-time based on changes in the monitored network traffic. The dynamic routing profiles may cause nodes to selectively route traffic to a subset of available ports, thereby allowing unused ports to enter a low-power state. In some implementations, the processor(s) 22 may instruct each node to route traffic defined as critical traffic to all available ports and traffic defined as non-critical traffic to the subset of available ports.

The network orchestrator 20 may execute method 300 for managing power consumption in a node interconnect network. One or more of the steps of method 300 may be performed by the processor(s) 22 of orchestrator 20 being configured to perform the steps. The steps of method 300 may be performed in any suitable order.

The method 300 may begin at step 302 with analyzing link requirements. At step 304, the method 300 may configure dynamic routing profiles based on the link requirements. The method 300 may then proceed to step 306, where nodes 12 are instructed to implement dynamic routing profiles.

At step 308, the method 300 may monitor network traffic, which can include receiving network traffic data monitored by nodes 12. The method 300 may continue to step 310, where dynamic routing profiles are adjusted in real-time based on changes in monitored network traffic.

In some implementations, at step 312, the method 300 may reallocate power saved from unused ports entering the low-power state to node compute resources. After step 312, the method 300 may return to step 306 to continue the process.

By configuring and adjusting dynamic routing profiles, the network orchestrator 20 may manage power consumption in the node interconnect network while maintaining efficient network operation.

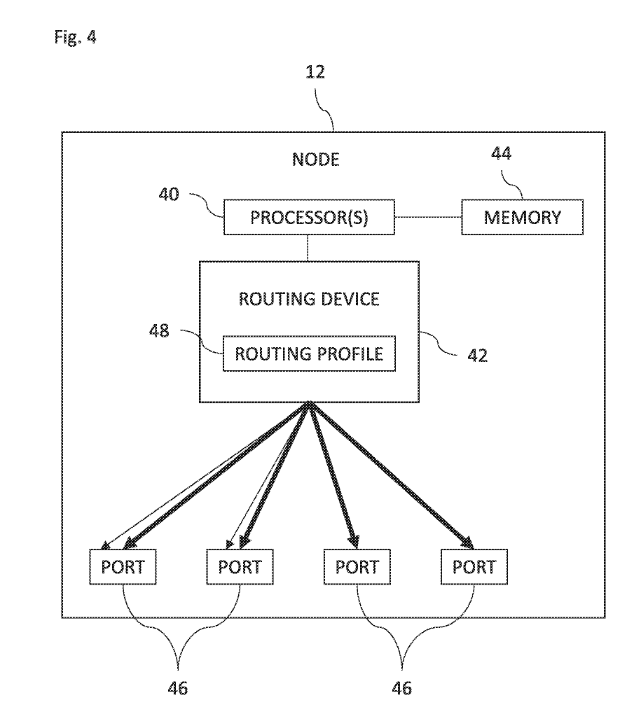

Reference is now made to FIG. 4, which is a block diagram of a processing node 12. A processing node 12 may comprise processor(s) 40, a routing device 42, memory 44, and communication ports 46. In some cases, the processing node 12 may be a graphics processing unit (GPU) or a central processing unit (CPU).

The processor(s) 40 may be connected to both the routing device 42 and the memory 44. The routing device 42 may contain a routing profile 48 and may be connected to multiple communication ports 46. The communication ports 46 may provide interfaces for connecting the processing node 12 to network links.

The routing device 42 may manage the routing of network traffic from the processor(s) 40 through the communication ports 46 based on the routing profile 48. In some cases, the routing device 42 may selectively route traffic to different communication ports 46 according to the routing profile 48 stored within the routing device 42.

The memory 44 may be connected to the processor(s) 40 and may store data and instructions used by the processor(s) 40. In some cases, the memory 44 may store the routing profile 48 or other data related to network traffic management.

The communication ports 46 may connect the processing node 12 to links of a network. In some cases, the number and configuration of communication ports 46 may vary depending on the specific requirements of the network architecture.

The routing profile 48 within the routing device 42 may contain instructions or parameters for managing network traffic. In some cases, the routing profile 48 may be dynamically updated based on network conditions or instructions from network orchestrator 20.

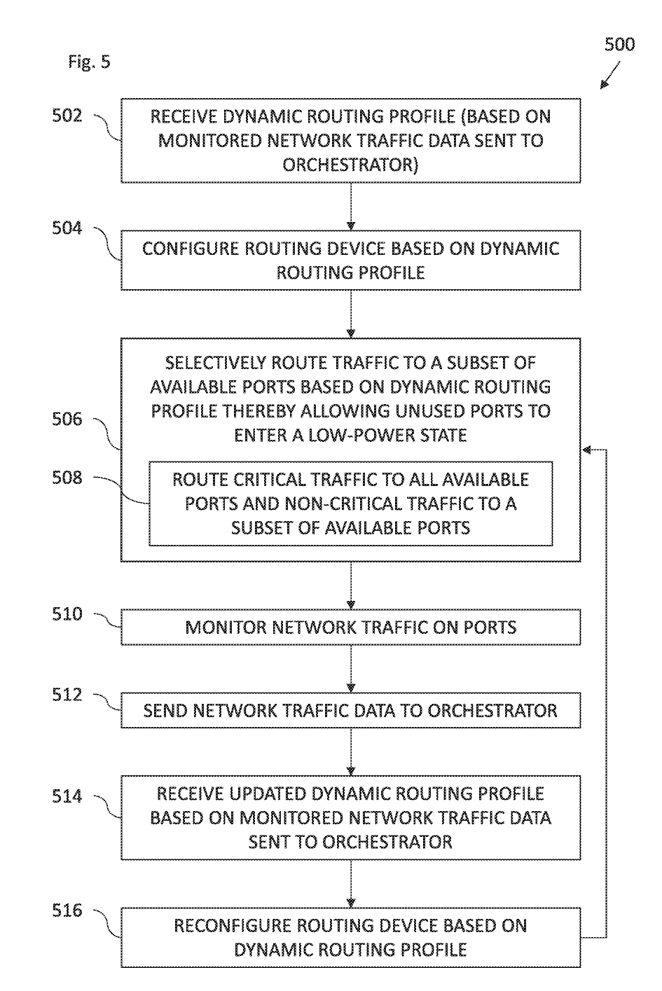

Reference is now made to FIG. 5, which is a flowchart illustrating a method 500 for managing power consumption in processing node 12. The method 500 may include several steps for implementing dynamic routing profiles and selectively routing network traffic. One or more of the steps of method 500 may be performed by the processor(s) 40 of node 12 being configured to perform the steps. The steps of method 500 may be performed in any suitable order.

In some cases, the method 500 may begin with a step 502 of receiving dynamic routing profile 48. The processor(s) 40 of the processing node 12 may receive the dynamic routing profile 48 from orchestrator 20. The dynamic routing profile 48 may be generated based on monitored network traffic data previously sent to the orchestrator 20.

The method 500 may proceed to a step 504 of configuring routing device 42. The processor 40 may configure the routing device 42 based on the received dynamic routing profile 48. This configuration may determine how network traffic is routed through the processing node's communication ports 46.

A step 506 of the method 500 may involve the routing device 42 selectively routing traffic to a subset of available ports 46 based on the dynamic routing profile 48. This selective routing may allow unused ports 46 to enter a low-power state, such as an L1 state (e.g., after a given timeout of no traffic on each port 46). In some cases, as shown in step 508, the routing device 42 may route traffic defined as critical traffic to all available ports 46 and traffic defined as non-critical traffic to the subset of available ports 46. In some cases, the critical traffic may be routed to a larger subset of available ports than the non-critical traffic. Traffic may be defined as critical or non-critical based on indications provided in headers of the packets of the traffic, for example, using QoS data.

The routing profile 48 instructs the routing device 42 how to route traffic out of a node 12 via some of the ports 46 of the node 12 while a subset of ports 46 are allowed to become idle and enter, and remain in, L1 state. However, if other nodes 12 are not configured correctly, the subset of ports 46 may not remain idle as desired and may not enter, and remain in, L1 state. Specifically, the subset of ports should be unused for both transmitting and receiving traffic to enter, and remain in, the L1 state.

To achieve this, the orchestrator 20 may configure the routing profiles of other nodes 12 to avoid sending traffic to the ports intended to enter the L1 state. This coordinated approach may ensure that a port is unused in both directions - for transmitting from its own node and for receiving from other nodes.

In some cases, the routing profiles of each node 12 may be generated with consideration for this two-way nature of the ports. The orchestrator 20 may analyze the network topology and traffic patterns to identify opportunities where specific ports on multiple nodes can be simultaneously unused for both transmit and receive operations.

For example, if the orchestrator 20 determines that a particular port on node A can enter L1, it may not only configure node A's routing profile to avoid sending traffic through that port, but also adjust the routing profiles of other nodes that might typically send traffic to that port on node A. This coordinated configuration may allow the port to remain inactive and enter the L1 state.

In some implementations, the orchestrator 20 may use a holistic approach when generating routing profiles, considering the potential L1 state opportunities across the entire network. This may involve balancing the desire for power savings through L1 state entry with the need to maintain sufficient active connections for network performance and redundancy.

The dynamic nature of the routing profiles may allow for adaptive management of these two-way port considerations. As network conditions change, the orchestrator 20 may adjust routing profiles across multiple nodes to create new opportunities for ports to enter L1 or to reactivate ports as needed to handle increased traffic demands.

The method 500 may include a step 510 of monitoring network traffic on the ports 46. The processor 40 may monitor the network traffic to gather data on current usage patterns and performance. This monitoring may be followed by a step 512 of sending network traffic data to the orchestrator 20. The processor 40 may send this data to inform the orchestrator of the current network conditions at the processing node 12.

In some cases, the method 500 may include a step 514 of receiving an updated dynamic routing profile 48. The processor 40 may receive this updated profile from the orchestrator 20 based on the sent network traffic data. This updated profile 48 may reflect changes in network conditions or requirements.

The method 500 may conclude with a step 516 of reconfiguring the routing device 42. The processor 40 may reconfigure the routing device 42 based on the updated dynamic routing profile 48. This reconfiguration may adjust the subset of ports 46 to which traffic is selectively routed, potentially changing which ports 46 enter or exit the low-power state.

After step 516, the method 500 may return to step 506 to continue selectively routing traffic according to the reconfigured routing profile 48. This cycle of monitoring, updating, and reconfiguring may allow the processing node 12 to adapt its routing behavior to changing network conditions and requirements, potentially optimizing power consumption and performance over time.

In some implementations, the system may handle unexpected traffic on ports intended to be in a low-power state. While the routing device 42 may be configured to route traffic to a specific subset of ports 46 based on the current routing profile 48, the remaining ports may still be capable of receiving packets. If a port 46 that is not part of the active subset receives traffic, it may automatically transition from the low-power state (such as L1) to an active state to process the incoming packets.

This behavior may occur in various scenarios, such as when there is a delay in other nodes implementing updated routing profiles, or in cases of routing errors. The system may be designed to maintain network reliability by ensuring that no packets are dropped due to ports being in a low-power state.

When a port 46 in a low-power state receives traffic, it may quickly exit the L1 state and become fully operational to handle the incoming data. After processing the received packets, the port may then wait for a predetermined period of inactivity before transitioning back to the L1 state.

The routing device 42 may be notified when a port exits the L1 state due to unexpected traffic. In some cases, this information may be used to temporarily adjust the routing behavior or to inform the orchestrator 20 of potential misalignments in routing profiles across the network. The orchestrator 20 may use this data to refine its routing profile configurations and improve the coordination of power management strategies across multiple nodes.

By allowing ports to dynamically respond to incoming traffic, even when they are intended to be in a low-power state, the system may maintain network flexibility and resilience while still pursuing overall power optimization goals. This approach may help to prevent data loss and ensure that the network can adapt to unexpected traffic patterns or temporary inconsistencies in routing configurations across different nodes.

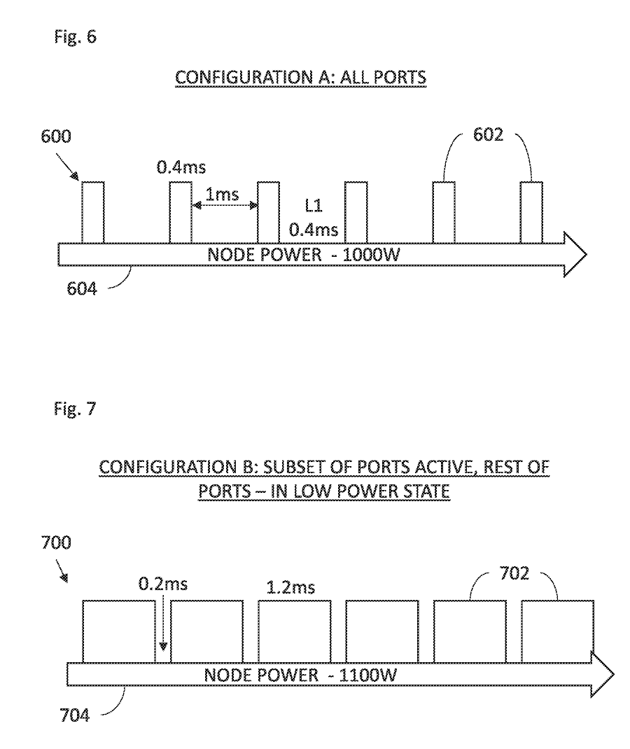

Reference is now made to FIGS. 6 and 7, which are port power graphs illustrating different configurations. FIG. 6 illustrates a port power graph 600 showing a configuration where all ports 46 of nodes 12 are active. The port power graph 600 depicts active periods 602 of port operation along a timeline indicated by arrow 604. FIG. 6 shows active periods 602 with intervals of 0.4 millisecond (ms) duration separated by 1ms gaps of inactivity, with an L1 state period of 0.4 ms. The ports do not enter L1 immediately after an active period ceases due to exit latency of the L1 state. Therefore, the ports enter L1 state after 0.6 ms of inactivity leading to an L1 state period of 0.4 ms. In such a scenario, the ports are in L1 state for about 28% of the time. In the example of FIG. 6, the power level available for computing power by the nodes 12 is 1000W.

FIG. 7 illustrates a port power graph 700 showing a configuration where a subset of ports 46 are active while the remaining ports 46 of nodes 12 are in a low power state, e.g., L1. FIG. 7 shows active periods 702 with intervals of 1.2 ms duration separated by 0.2 ms gaps of inactivity, with no L1 state being achieved in the gap of inactivity. If half of the ports are active with conveying traffic and half of the ports do not convey traffic, but are in L1 state, then L1 state is achieved by 50% of the ports for the whole time period. The saved power may be transferred for use by the compute function of the nodes 12, leading to a power level available for computing power by the nodes 12 equal to 1100W.

The comparison between the port power graphs 600 and 700 highlight the power savings that may be achieved through selective port activation. In the configuration shown in the port power graph 700, unused ports may enter a low-power state, potentially reducing overall power consumption or providing saved power to compute functionality.

In some cases, orchestrator 20 may reallocate power saved from unused ports entering the low-power state to node compute resources. This reallocation may allow for increased computational capacity or improved performance in other areas of the nodes, potentially offsetting any performance impact from the reduced number of active ports.

The port power graphs 600 and 700 may illustrate how selective routing and port activation can lead to more efficient power utilization in a node interconnect network. By allowing unused ports to enter a low-power state, the system may achieve power savings while maintaining necessary network connectivity and potentially improving overall system performance through power reallocation.

In some cases, the system for managing power consumption in a node interconnect network may be implemented with alternative network topologies. For example, the network may utilize a fat tree topology, a torus topology, or a dragonfly topology instead of the mesh-like topology described previously. These alternative topologies may offer different trade-offs in terms of scalability, latency, and bandwidth that may be advantageous for certain applications or workloads.

While the system has been primarily described in the context of GPU-based computing systems, the power management techniques may be applied to other types of node interconnect networks. For example, the system may be implemented in high-performance computing clusters composed of CPUs, field-programmable gate arrays (FPGAs), or application-specific integrated circuits (ASICs). The principles of selectively routing traffic to subsets of available ports to allow unused ports to enter low-power states may be applicable across various computing architectures.

In some cases, the granularity of power management may be adjusted. Rather than managing power at the port level, the system may operate at a finer granularity, such as individual lanes within a port. This may allow for more precise control over power consumption in scenarios where partial port utilization is common.

The system may incorporate machine learning techniques to optimize routing profiles. By analyzing historical traffic patterns and system performance metrics, machine learning models may predict future network usage and proactively adjust routing profiles to maximize power efficiency while maintaining performance targets.

The power management techniques described may be applied to other types of interconnects beyond node-to-node communication networks. For example, similar principles may be used to manage power consumption in storage area networks or in-memory interconnects within individual compute nodes.

In some implementations, the system may support heterogeneous networks where different types of links with varying power characteristics coexist. The routing profiles and power management strategies may be tailored to account for these differences, potentially prioritizing the use of more power-efficient links when possible.

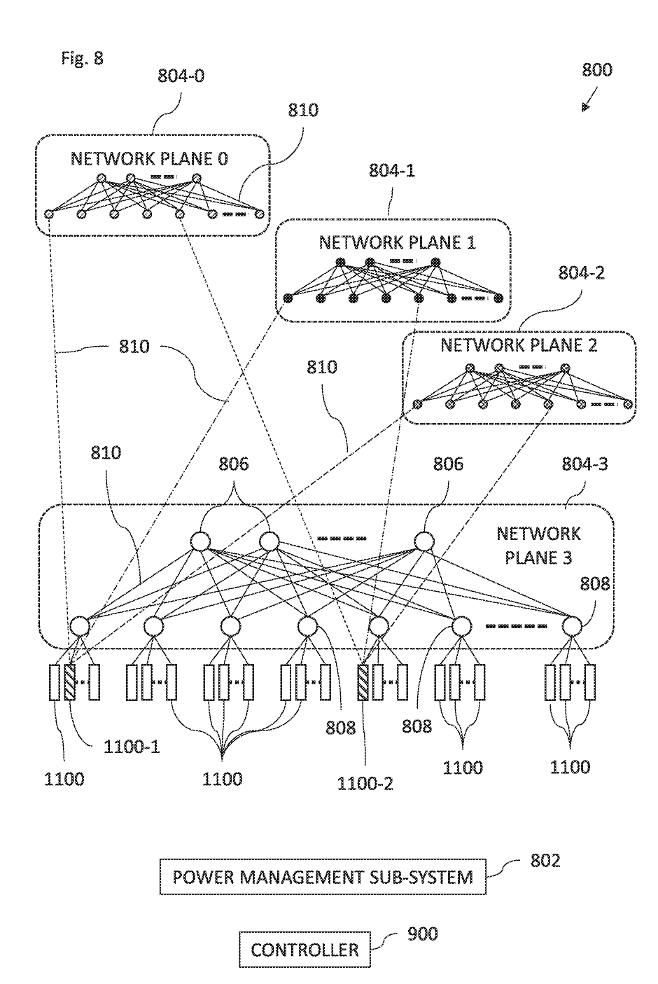

Reference is now made to FIG. 8, which is a block diagram illustrating a network system 800 for managing power consumption across multiple network planes. The network system 800 comprises a plurality of network planes, specifically four network planes 804-0,804-1, 804-2, and 804-3, each providing a separate data communication path within the network system 800. The system 800 may include any suitable number of network planes 804.

Each network plane of the plurality of network planes comprises spine switches 806 (only some labeled for the sake of simplicity) and leaf switches 808 (only some labeled for the sake of simplicity) arranged in a hierarchical topology. In some embodiments, different network topologies may be used. Network links 810 (only some labeled for the sake of simplicity) connect the spine switches 806 to the leaf switches 808 within each network plane.

The network system 800 comprises a plurality of network-enabled devices 1100 (only some labeled for the sake of simplicity), including a network-enabled device 1100-1, and a network-enabled device 1100-2. Each of the network-enabled devices 1100 is connected to each of the network planes through the leaf switches 808, for example via different ports of that network-enabled device 1100. The network-enabled devices 1100 are connected to the leaf switches 808 of the multiple network planes 804 via network links 810. In the example of FIG. 8, the network-enabled device 1100-1 may connect to the network-enabled device 1100-2 via any one or more of the network planes 804-0, 804-1, 804-2, and 804-3 simultaneously using selected ports.

For example, port 0 of the network-enabled devices 1100-1 and 1100-2 may enable connection via the network plane 804-0, while port 1 of the network-enabled devices 1100-1 and 1100-2 may enable connection via the network plane 804-1, and other ports may enable connections via the other network planes.

A power management subsystem 802 is configured to manage power states across the plurality of network planes. The power management subsystem 802 may be distributed and may include elements in the network-enabled devices, switches, and other network elements within the network system 800. The network planes may support L0 (active) and L1 (standby/slumber) power states. In some cases, the network planes may include L0s (idle) and L2 (sleep) power states in addition to L0 and L1 power states.

A controller 900 is configured to coordinate traffic routing and power optimization across the network system 800. The controller 900 may be a central orchestrator and/or may be distributed over the network, such as in the network-enabled devices and/or in other network nodes. The controller 900 is configured to select which network planes remain active and which network planes may enter lower power states based on network traffic demands. The network links 810 provide connectivity between all components of the network system 800, enabling data transmission across selected network planes while allowing unused planes to enter power-saving modes.

In some cases, the controller 900 may be configured to consolidate traffic onto a subset of the plurality of network planes, allowing unused network planes to transition to lower power states such as L1 or L2. For example, during periods of reduced network activity, the controller 900 may direct all traffic through the network plane 804-0 and the network plane 804-1, while allowing the network plane 804-2 and the network plane 804-3 to enter L1 power states. This consolidation may enable entire switch fabrics within the unused planes to power down, achieving energy savings while maintaining network performance.

Alternative embodiments may include different numbers of network planes, such as two, eight, or sixteen network planes. The spine switches 806 and leaf switches 808 may be implemented using various switching technologies, including Ethernet switches, InfiniBand switches, or other high-speed networking equipment. The network-enabled devices may include servers, graphics processing units, storage devices, or other computing equipment that generates or processes network traffic.

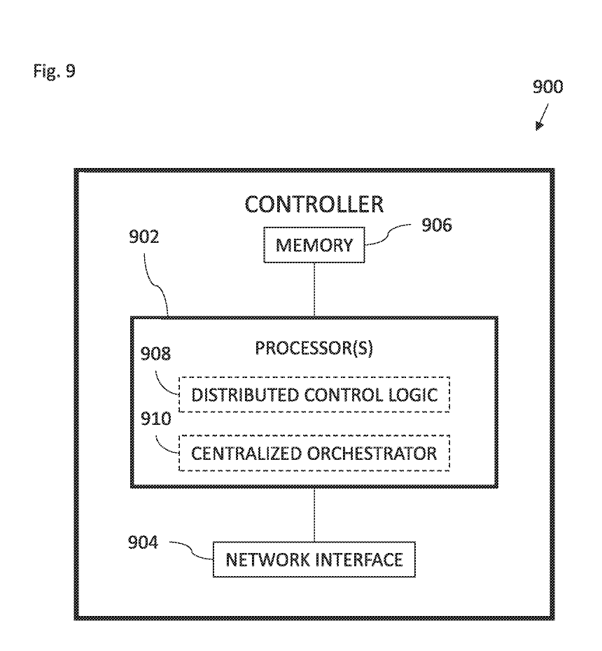

Reference is now made to FIG. 9, which illustrates a block diagram of a controller 900. The controller 900 includes one or more processors 902, a network interface 904, and a memory 906. The controller 900 may be configured to manage network plane selection and power optimization functions across the multi-plane network architecture described herein.

The processor(s) 902 may be configured to execute various control functions for managing power states and traffic routing across multiple network planes. In some cases, the processor(s) 902 may contain distributed control logic 908 and/or a centralized orchestrator 910. The distributed control logic 908 may be configured to operate in a decentralized manner, where control decisions are made locally within individual network-enabled devices and as such the functionality of the controller 900 may be implemented in each, or in a multiplicity, of the network-enabled devices 1100. The distributed control logic 908 and/or the centralized orchestrator 910 may be configured to coordinate power states across network planes to synchronize transitions between power modes for network-wide energy optimization.

The network interface 904 may be configured to provide connectivity for the controller 900 to communicate with other network components. The network interface 904 may be configured to enable the controller 900 to send control signals and receive status information from network-enabled devices and network infrastructure components across the multiple network planes.

The memory 906 may be configured to store data and instructions used by the processor(s) 902. In some cases, the memory 906 may store traffic patterns, power state information, configuration parameters, and algorithms for network plane selection and power optimization. The memory 906 may also store historical data used for predictive power management functions.

The distributed control logic 908 may be configured to enable decentralized decision-making where each network-enabled device independently selects a respective subset of network planes over which to send traffic. In some cases, the distributed control logic 908 may be integrated within each network-enabled device, allowing for autonomous power optimization decisions based on local traffic conditions and requirements.

The centralized orchestrator 910 may be configured to coordinate power management across multiple network-enabled devices and network planes. The centralized orchestrator 910 may be configured to select a subset of network planes for multiple network-enabled devices to coordinate power states across the network planes. In some cases, the centralized orchestrator 910 may be configured to synchronize transitions between power modes for network-wide energy optimization, allowing unused network planes to enter lower power modes while maintaining network performance and redundancy.

The processor(s) 902 may be configured to execute processing circuitry that selects a subset of network planes for one or more of the network-enabled devices 1100 to send traffic over, allowing one or more unused network planes to enter a lower power mode. The processing circuitry may be configured to instruct network-enabled devices 1100 to route traffic through the selected subset of network planes while bypassing unused network planes.

In alternative embodiments, the controller 900 may include multiple processors 902 operating in parallel to handle different aspects of network management. The distributed control logic 908 and centralized orchestrator 910 may operate simultaneously, with the distributed control logic 908 handling local optimization decisions while the centralized orchestrator 910 manages global coordination. The network interface 904 may include multiple communication channels to interface with different network planes or device types.

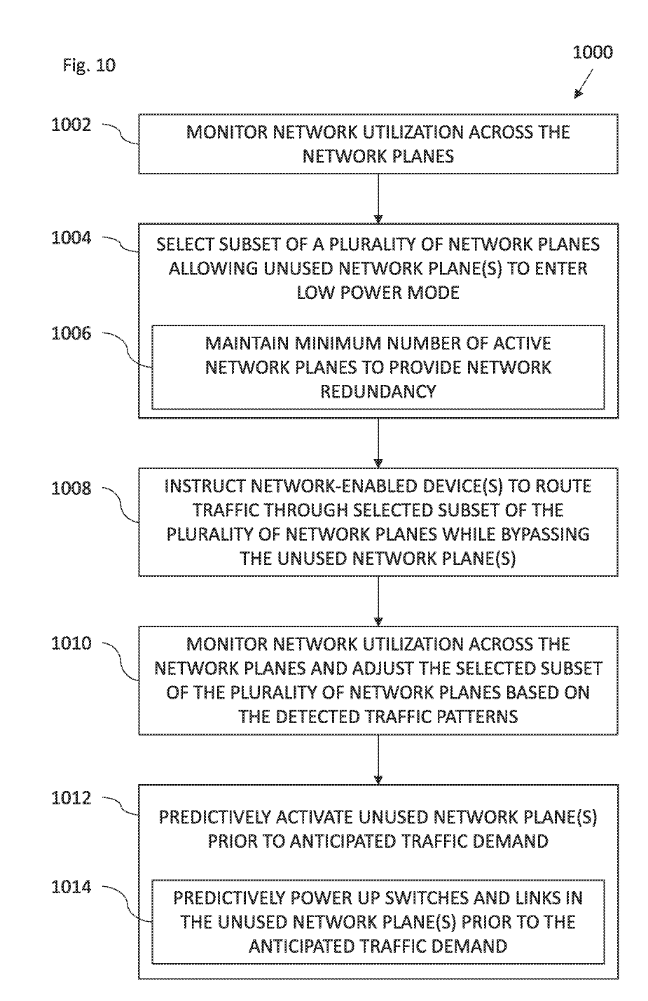

Reference is now made to FIG. 10, which illustrates a method 1000 for network power optimization. The method 1000 provides a systematic approach for managing power consumption across multiple network planes while maintaining network performance and reliability.

The method 1000 begins with a step 1002 where processor(s) 902 of controller 900 are configured to monitor network utilization across network planes. During step 1002, the processor(s) 902 may be configured to collect telemetry data from network-enabled devices, switches, and network links to assess current traffic patterns, bandwidth usage, and performance metrics across each network plane. The processor(s) 902 may be configured to analyze historical traffic patterns, apply machine learning algorithms, or process scheduled workload information to understand network utilization trends.

Based on the monitoring phase, the method 1000 includes a step 1004 where the processor(s) 902 are configured to select a subset of a plurality of network planes, automatically allowing unused network plane(s) to enter low power mode. During step 1004, the processor(s) 902 may be configured to evaluate current traffic volume, time of day, energy consumption data, quality-of-service requirements, or schedule sensitivity to determine which network planes should remain active. The processor(s) 902 may be configured to consolidate data flows onto fewer planes and physical links, allowing unused switches to enter low-power states or shut down entirely. The processor(s) 902 may be configured to batch idle periods across multiple links and planes to allow entire switches or planes to enter low-power states during coordinated idle windows.

Step 1004 may include a sub-step 1006 where the processor(s) 902 are configured to maintain a minimum number of active network planes to provide network redundancy. During sub-step 1006, the processor(s) 902 may be configured to ensure that sufficient network planes remain active to handle traffic loads and provide fault tolerance in case of network failures. The processor(s) 902 may be configured to select the subset of network planes based on quality-of-service requirements associated with different types of network traffic, ensuring that critical applications maintain appropriate service levels.

The method 1000 includes a step 1008 where the processor(s) 902 are configured to instruct network-enabled device(s) to route traffic through the selected subset of the plurality of network planes while bypassing the unused network plane(s). During step 1008, the processor(s) 902 may be configured to send control signals to network-enabled devices specifying which network planes should be used for traffic routing. The processor(s) 902 may be configured to coordinate traffic distribution to optimize performance and power consumption across the selected network planes. This may include notifying network-enabled devices of the selected subset using routing tables which include path selection entries from which to select paths over the selected subset and avoid the unused network plane(s).

At a step 1010, the processor(s) 902 are configured to continue to monitor network utilization across the network planes and adjust the selected subset based on detected traffic patterns. During step 1010, the processor(s) 902 may be configured to continuously assess network conditions and modify the active network plane configuration as traffic demands change. The processor(s) 902 may be configured to work in conjunction with data center thermal management systems to distribute traffic and adjust power states to prevent formation of localized hot spots. The processor(s) 902 may be configured to integrate with higher-layer protocols and orchestration frameworks to align power states with workload schedules.

At a step 1012, the processor(s) 902 are configured to predictively activate unused network plane(s) prior to anticipated traffic demand. During step 1012, the processor(s) 902 may be configured to use historical traffic patterns, machine learning algorithms, or scheduled workload information to predict future traffic requirements. The processor(s) 902 may be configured to implement predictive wake-up using workload telemetry to preemptively wake NICs, switches, or entire planes before traffic is sent. The processor(s) 902 may be configured to synchronize state exits to avoid cascading delays in multi-tiered topologies.

Step 1012 may include a sub-step 1014 where the processor(s) 902 are configured to predictively power up switches and links in the unused network plane(s) prior to the anticipated traffic demand. During sub-step 1014, the processor(s) 902 may be configured to coordinate the activation sequence of network components to minimize wake-up latency and ensure smooth transitions from low-power states to active operation. The processor(s) 902 may be configured to prioritize critical links to remain in lower-latency power states while managing non-critical links appropriately.

In some cases, the processor(s) 902 may be configured to enforce uniform power management policies across devices and vendors to ensure consistent behavior throughout the network system. The processor(s) 902 may be configured to use machine learning algorithms applied to telemetry data to refine prediction models and policy decisions, continuously improving the accuracy of traffic demand forecasting and power optimization strategies.

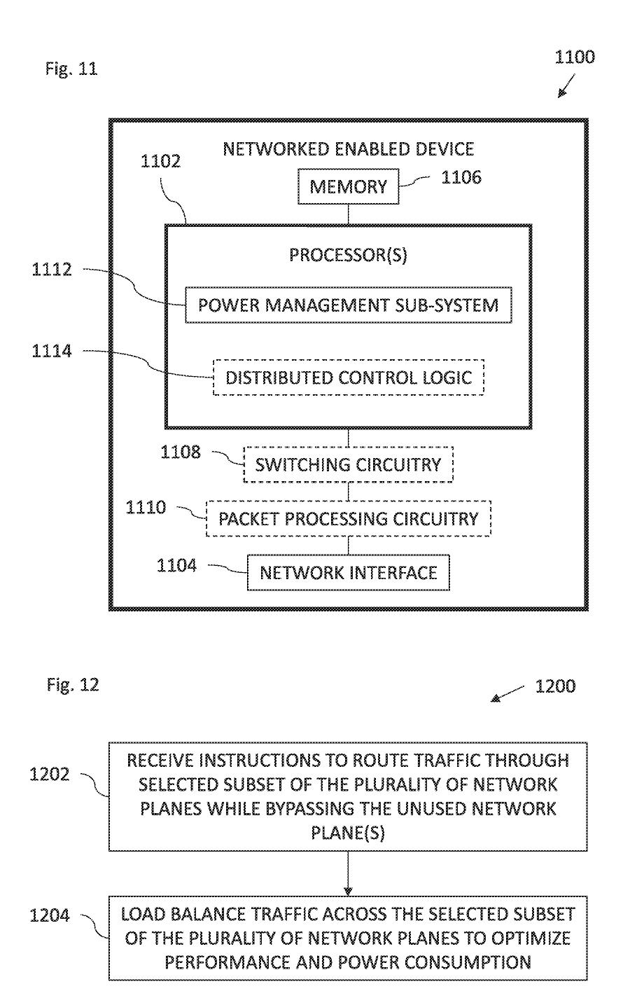

Reference is now made to FIGS. 11 and 12, which illustrate a network-enabled device 1100 architecture and a routing method 1200 for managing traffic distribution across multiple network planes.

As shown in FIG. 11, network-enabled device 1100 includes a processor 1102, a network interface 1104, and a memory 1106. The processor 1102 may be configured to execute instructions and coordinate operations within the network-enabled device 1100. The network interface 1104 may be configured to provide connectivity for communication with external network components across multiple network planes. The memory 1106 may be configured to store data and instructions used by the processor 1102 during operation.

The network-enabled device 1100 may include switching circuitry 1108 positioned between the processor 1102 and the network interface 1104. The switching circuitry 1108 may be configured to handle routing and switching of network traffic . In some cases, the switching circuitry 1108 may be configured to direct traffic flows to specific network planes based on routing decisions made by the processor 1102.

The network-enabled device 1100 may also include packet processing circuitry 1110 connected between the processor 1102 and the network interface 1104. The packet processing circuitry 1110 may be configured to process network packets, including functions such as packet inspection, modification, and forwarding. In some cases, the packet processing circuitry 1110 may be configured to work in conjunction with the switching circuitry 1108 to optimize packet handling across multiple network planes.

A power management subsystem 1112 may be integrated within the network-enabled device 1100. The power management subsystem 1112 may be configured to manage power consumption within the network-enabled device 1100 and coordinate with external power management systems. In some cases, the power management subsystem 1112 may be configured to monitor power states of network connections and adjust power consumption based on traffic patterns.

The network-enabled device 1100 may include distributed control logic 1114 executed by the processor 1102. The distributed control logic 1114 may be configured to make local routing decisions and coordinate with other network-enabled devices or centralized controller(s). In some cases, the distributed control logic 1114 may be configured to select which network planes to utilize for outgoing traffic based on current network conditions and power optimization goals.

Reference is now made to FIG. 12, which illustrates a routing method 1200 performed by the network-enabled device 1100. The routing method 1200 includes a step 1202 where the processor 1102 is configured to receive instructions to route traffic through a selected subset of a plurality of network planes while bypassing unused network planes. In some cases, the processor 1102 may be configured to receive these instructions from a centralized orchestrator or generate them locally using the distributed control logic 1114.

The routing method 1200 includes a step 1204 where the processor 1102 is configured to load balance traffic across the selected subset of the plurality of network planes. The processor 1102 may be configured to distribute traffic flows among the active network planes to optimize performance and power consumption. In some cases, the processor 1102 may be configured to adjust load balancing algorithms based on current traffic volumes, quality-of-service requirements, or power optimization objectives.

The network-enabled device 1100 may be configured to optimize performance and power consumption through load balancing operations performed by the processor 1102. The load balancing may involve distributing network traffic across multiple active network planes while avoiding unused planes that have entered lower power modes. In some cases, the processor 1102 may be configured to monitor traffic patterns and dynamically adjust the distribution of traffic flows to maintain optimal performance while minimizing power consumption.

Alternative embodiments of the network-enabled device 1100 may include different configurations of the switching circuitry 1108 and packet processing circuitry 1110. In some cases, these components may be integrated into a single processing unit or distributed across multiple specialized processors. The power management subsystem 1112 may be implemented as software running on the processor 1102 or as dedicated hardware components. The distributed control logic 1114 may operate independently or in coordination with centralized control systems depending on the specific network architecture requirements.

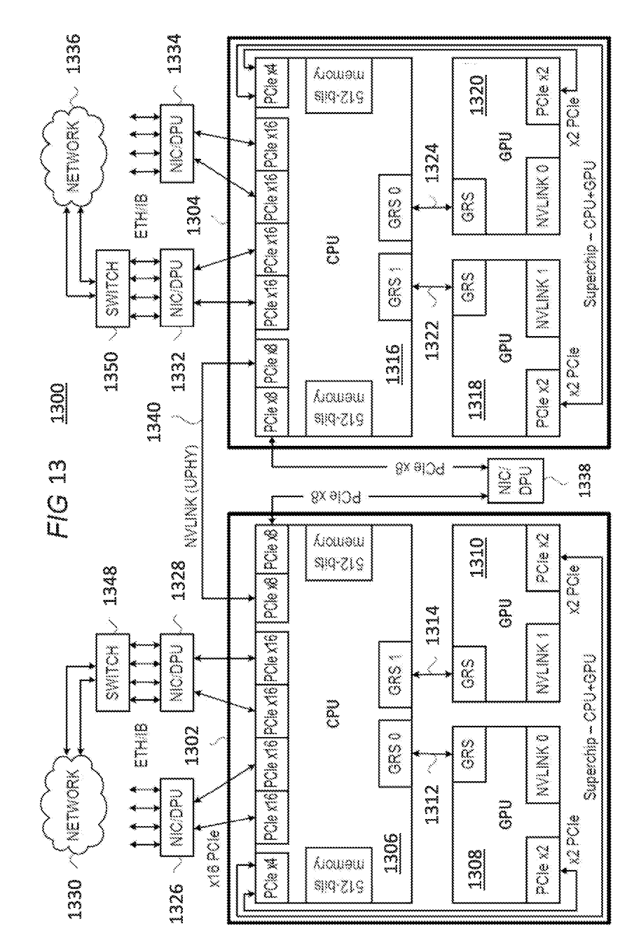

Reference is now made to FIG. 13, which is a block diagram that schematically illustrates a computing system 1300, e.g., a data center or a High-Performance Computing (HPC) cluster, in accordance with an embodiment of the present disclosure.

System 1300 comprises a plurality of subsystems, e.g., multiple processing devices coupled to each other, multiple network devices, and multiple networks, according to at least one embodiment. Computing system 1300 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1300 and to one or more external networks 1330, 1336. In the present example, system 1300 comprises a packet switch 1348 that connects NIC/DPU 1328 to network 1330, and a packet switch 1350 that connects NIC/DPU 1332 to network 1336.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1300 can include one or more CPUs and one or more GPUs.

FIG. 13 also demonstrates an example architecture of a multi-GPU architecture. As illustrated in the figure, computing system 1300 includes a processing device 1302 with a multi-GPU architecture. In particular, processing device 1302 may be a system-on-chip and includes multiple subsystems such as a CPU 1306, a GPU 1308, and a GPU 1310. CPU 1306 can be coupled to GPU 1308 via a die-to-die (D2D) or chip-to-chip (C2C) interconnect 1312, such as a Ground-Referenced Signaling interconnect (GRS interconnect). CPU 1306 can be coupled to GPU 1310 via a D2D or C2C interconnect 1314. CPU 1306 can also couple to GPU 1308 and GPU 1310 via PCIe interconnects.

CPU 1306 can be coupled to one or more NICs or DPUs, which are coupled to one or more networks. For example, as illustrated in FIG. 13, CPU 1306 is coupled to a first NIC/DPU 1326, which is coupled to a network 1330. CPU 1306 is also coupled to a second NIC/DPU 1328, which is coupled to network 1330 via switch 1348. NIC/DPU 1326 and NIC/DPU 1328 can be coupled to network 1330 over Ethernet (ETH), NVLINK or InfiniBand (IB) connections, for example.

Computing system 1300 also includes a processing device 1304 with a multi-GPU architecture. In particular, processing device 1304 includes multiple subsystems including a CPU 1316, a GPU 1318, and a GPU 1320. CPU 1316 can be coupled to GPU 1318 via a D2D or C2C interconnect 1322. CPU 1316 can be coupled to GPU 1320 via a D2D or C2C interconnect 1324. CPU 1316 can also couple to GPU 1318 and GPU 1320 via PCIe interconnects. CPU 1316 can be coupled to one or more NICs or DPUs, which are coupled to one or more networks. For example, as illustrated in FIG. 13, CPU 1316 is coupled to a first NIC/DPU 1332, which is coupled to a network 1336. CPU 1316 is also coupled to a second NIC/DPU 1334, which is coupled to network 1336 via switch 1350. NIC/DPU 1332 and NIC/DPU 1334 can be coupled to network 1336 over Ethernet (ETH), NVLINK or InfiniBand (IB) connections.

In at least one embodiment, processing device 1302 and processing device 1304 can communicate with each other via a NIC/DPU 1338, such as over PCIe interconnects. Processing device 1302 and processing device 1304 can also communicate with each other over a high-bandwidth communication interconnect 1340, such as an NVLink interconnect or other high-speed interconnects. The packet switches in FIG. 13 may comprise, for example, Nvidia Quantum-2 switches. The NICs/DPUs in the figure may comprise, for example, Nvidia Bluefield DPUs.

The network-enabled device 1100 may be any suitable device, such as: an accelerator device; a processing device including a central processing unit (CPU) and/or a graphics processing unit (GPU); a host device connected to one or more peripheral devices; a peripheral device connected to another peripheral device and/or one or more host devices; a network device, e.g., a network interface controller (NIC) device, a data processing unit (DPU) or smart NIC including a NIC and one or more processing cores, or a network switch. One or more of the processing steps described herein may be performed by a CPU, GPU, DPU, NIC, or any suitable combination thereof.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer’s motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer’s memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC’s operation, such as speed settings, interrupt configurations, and buffer sizes; firmware/ROM that contains the embedded software that controls the NIC’s operations and manages network protocols.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The various elements described herein as performing particular tasks or steps may be configured to, adapted to, operative to, designed to, programmed to, or otherwise arranged to perform such tasks or steps. In some embodiments, these elements may include hardware components, software modules, firmware, or any combination thereof that enable the performance of the described functionality. The elements may be implemented using processing circuitry, dedicated hardware, programmable logic, or other suitable technologies that allow for the execution of the specified operations. Additionally, these elements may be selectively activated, controlled, or coordinated to perform their respective functions as part of the overall system operation.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form "a", "an" and "the" include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system for network power optimization, comprising:
a plurality of network planes;
a plurality of network-enabled devices, each of the network-enabled devices being connected to each of the network planes; and
a controller to select a subset of the plurality of network planes for at least one network-enabled device of the plurality of network-enabled devices to send traffic over, allowing at least one unused network plane to enter a lower power mode.

2. The system of claim 1, further comprising a power management subsystem to control power modes of the plurality of network planes and transition the at least one unused network plane to the lower power mode.

3. The system of claim 1, wherein the controller comprises distributed control logic integrated within each of the plurality of network-enabled devices, wherein the distributed control logic in each network-enabled device is to select a respective subset of the plurality of network planes over which to send traffic.

4. The system of claim 1, wherein the controller is a centralized orchestrator to select the subset of the plurality of network planes over which to send traffic for multiple network-enabled devices of the plurality of network-enabled devices to coordinate power states across the plurality of network planes to synchronize transitions between power modes for network-wide energy optimization.

5. The system of claim 1, wherein the controller is to select the subset of the plurality of network planes based on any one or more of the following: current traffic volume; a time of day; energy consumption data; quality-of-service requirements; or schedule sensitivity.

6. The system of claim 1, wherein each network plane of the plurality of network planes comprises spine switches and leaf switches arranged in a hierarchical topology.

7. The system of claim 6, wherein the plurality of network-enabled devices are connected to leaf switches across multiple network planes of the plurality of network planes.

8. The system of claim 1, wherein the controller instructs the at least one network-enabled device to route traffic through the selected subset of the plurality of network planes while bypassing the at least one unused network plane.

9. The system of claim 1, wherein the controller is to predictively activate the at least one unused network plane prior to anticipated traffic demand based on any one or more of the following: historical traffic patterns; machine learning algorithms; or scheduled workload information.

10. The system of claim 9, wherein the controller is to predictively power up switches and links in the at least one unused network plane prior to the anticipated traffic demand.

11. The system of claim 1, wherein the controller is to maintain a minimum number of active network planes from the plurality of network planes to provide network redundancy.

12. The system of claim 1, wherein the controller is to select the subset of the plurality network planes based on quality-of-service requirements associated with different types of network traffic.

13. The system of claim 1, wherein the controller is to monitor network utilization across the plurality of network planes and adjust the selected subset based on detected traffic patterns.

14. The system of claim 1, wherein the at least one network-enabled device is to load balance traffic across the selected subset of the plurality of network planes to optimize performance and power consumption.

15. A controller for network power optimization, comprising:
processing circuitry to:
select a subset of a plurality of network planes for at least one network-enabled device to send traffic over allowing at least one unused network plane to enter a lower power mode; and
instruct the at least one network-enabled device to route traffic through the selected subset of the plurality of network planes while bypassing the at least one unused network plane; and
memory to store data used by the processing circuitry.

16. The controller of claim 15, wherein the processing circuitry is to coordinate power states across the plurality of network planes to synchronize transitions between power modes for network-wide energy optimization.

17. The controller of claim 15, wherein the processing circuitry is to select the subset of network planes based on any one or more of the following: current traffic volume; a time of day; energy consumption data; quality-of-service requirements; or schedule sensitivity.

18. The controller of claim 15, wherein the processing circuitry is to predictively activate the at least one unused network plane prior to anticipated traffic demand based on any one or more of the following: historical traffic patterns; machine learning algorithms; or scheduled workload information.

19. The controller of claim 18, wherein the processing circuitry is to predictively power up switches and links in the at least one unused network plane prior to the anticipated traffic demand.

20. The controller of claim 15, wherein the processing circuitry is to maintain a minimum number of active network planes from the plurality of network planes to provide network redundancy.

21. The controller of claim 15, wherein the processing circuitry is to select the subset of network planes based on quality-of-service requirements associated with different types of network traffic.

22. The controller of claim 15, wherein the processing circuitry is to monitor network utilization across the plurality of network planes and adjust the selected subset based on detected traffic patterns.

23. A method for network power optimization, comprising:
selecting a subset of a plurality of network planes for at least one network-enabled device to send traffic over allowing at least one unused network plane to enter a lower power mode; and
instructing the at least one network-enabled device to route traffic through the selected subset of the plurality of network planes while bypassing the at least one unused network plane.
